(19) United States
(12) Patent Application Publication
(10) Pub. No.: US 2006/0178200 A1
(43) Pub. Date: Aug. 10, 2006

(54) Gaming device

(76) Inventor: Kazutaka Shiraishi, Tokyo (JP)

Correspondence Address: GLOBAL IP COUNSELORS, LLP, 1233 20TH STREET, NW, SUITE 700, WASHINGTON, DC, 20036-2680, US

(21) Appl. No.: 11/275,758

(22) Filed: Jan. 26, 2006

(30) Foreign Application Priority Data
Jan. 27, 2005 (JP) 2005020025

(51) Int. Cl. A63F 13/00

(52) U.S. Cl. 463/20

(57) ABSTRACT

A display unit displays two or more symbol columns. A storage unit stores a symbol column table which matches the symbol column types with random numbers, as well as a pay table which matches prizes with symbol arrangements. An arrangement type lottery unit retrieves a symbol column type corresponding to a given random number or a given combination of random numbers from the symbol column table. A winning determination unit performs an internal lottery process, based on the symbol column type retrieved by the arrangement type lottery unit, and thereby determines a final symbol arrangement to be displayed by the display unit, and a prize to be awarded to a player. A display control unit controls the display unit, and provides a display of moving and stopped symbols by using the symbol column type retrieved by the arrangement type lottery unit.

### BACKGROUND OF THE INVENTION

1. Field of the Invention

The present invention relates to a gaming device which awards a prize to a player in accordance with a symbol arrangement.

2. Background Information

Conventional gaming devices perform a two-step lottery process which selects enabled symbols with a lottery process from a plurality of symbols that are displayed on reels, and then repeats an internal lottery process that uses the enabled symbols to finally determine whether to award a prize to a player. For example, a gaming device disclosed in U.S. Pat. No. 5,085,436 matches each stop position of the symbols with a unique number, and then selects some of these numbers at random to thereby select the final stop positions of the symbols at random. This gaming device, in particular, divides the random selection process into the following two steps. In the first step, the entire range of the numbers is divided into a plurality of sub-ranges, and then one of the sub-ranges which correspond to the generated random number is selected. In the second step, a number is selected at random from the numbers in the sub-range selected in the first step. The symbols are then statically displayed at the stop positions corresponding to the number selected. In addition, another gaming device disclosed in Published Japanese Patent Application No. 2004-121624 classifies its four reels into an A group and a B group, which each group having three of the reels, and then awards a prize to a player in accordance with the symbol arrangement displayed on either of the groups. Here, when specific symbols are to be lined up by means of the stop operation of the reels, a lottery process will be performed to determine whether to switch between the A and B groups. Thus, the gaming device performs the lottery procedure in two steps, one of which is to select each stop positions of the A group and the B group, and another of which is to switch between the A group and the B group.

However, conventional gaming devices such as those described above use reels with fixed symbols in fixed arrangements, and accordingly, similar displays will frequently appear while a game is repeated over and over again. For example, the two-step lottery process of the gaming device disclosed in U.S. Pat. No. 5,085,436 is simply an internal process included in the winning determination routine, and accordingly the reel display that is visible to a player will not change. In other words, this gaming device provides changes to the probability of winning, which, for example, allows specific symbols to appear more frequently, but produces no effects to cause the player to notice the change. On the other hand, the gaming device disclosed in Published Japanese Patent Application No. 2004-121624 is no different than other gaming devices, in that each of the four reels which are visible to the player has fixed symbols in a fixed arrangement.

As described above, there is no significant change in the symbol arrangements displayed on the reels in the above-described conventional gaming devices, and accordingly, similar displays will frequently appear while a game is repeated over and over again. This causes the player to gradually lose interest in game. However, significant changes in the range of selection of the enabled symbols in order to prevent the player from losing interest in game will complicate the advance consideration of the symbol arrangements and payout rates, and therefore places burdens on the designers of the gaming device. The burdens on the designers will be particularly difficult when a very advantageous arrangement of symbols is provided amongst a fixed arrangement of symbols that are limited in number and type.

In view of the above, there exists a need for a gaming device which overcomes the above mentioned problems in the prior art. This invention addresses this need in the prior art as well as other needs, which will become apparent to those skilled in the art from this disclosure.

### SUMMARY OF THE INVENTION

A gaming device of the present invention awards a prize to a player in accordance with an arrangement of a plurality of symbols, and preferably comprises the following units:

a display unit that displays at least a portion of a plurality of aligned symbol columns, each symbol column having a plurality of symbols;

a storage unit that stores a symbol column table showing the corresponding relationships between symbol column types and specific random numbers or specific combinations of random numbers, as well as a pay table showing the corresponding relationships between one or more prizes and a specific symbol arrangement;

a starting unit that generates a start signal in order to start a game, in response to an operation of a player;

a random number generating unit that generates a random number or a combination of random numbers upon receipt of the start signal;

an arrangement type lottery unit that retrieves, from the symbol column table, the symbol column type corresponding to the random number or the combination of random numbers generated by the random number generating unit;

a winning determination unit that performs an internal lottery based on the symbol column type retrieved by the arrangement type lottery unit, determines a final symbol arrangement to be displayed from the result of the internal lottery, and retrieves the final symbol arrangement from the pay table in order to determine a prize to be awarded to the player; and

a display control unit that causes the display unit to change the display of the symbol columns so that symbol columns of the type retrieved by the arrangement type lottery unit are substituted for the symbol columns that have already been displayed by the display unit, and the symbols included in the substituted symbol columns continuously move in the column direction for a predetermined period of time, and thereafter cause the display unit to stop the moving symbol display so that the final symbol arrangement determined by the winning determination unit appears.

The gaming device of the present invention will first select the symbol column type in accordance with the generated random number(s), and then will determine whether to award a prize to the player based on the newly selected symbol column type by using another lottery process (i.e., an internal lottery process). In this way, a game will be repeated while the arrangement of the symbols to be displayed on the reels changes. In particular, the display unit will display the substitution of the symbol column type. This type of dynamic display can cause the player to maintain interest in a game for a longer period of time. Preferably, a symbol arrangement corresponding to a large payout, which rarely appears under normal conditions, can appear at comparatively frequent intervals while the display of the symbol columns changes. Thus, the gaming device of the present invention can provide a great deal of variety to the game. On the other hand, the gaming device has a wide range of symbol selection because the types of symbols are not limited to the symbols actually displayed on the reels. This will reduce the burden on the designers of the gaming device.

The above-described gaming device of the present invention preferably comprises pay tables that differ for each symbol column type. The pay tables are switched in order to match the symbol column type used. This allows the total number of symbol columns to change, for example, from three to four, and accordingly, can further increase the variety of the game.

The above-described gaming device of the present invention preferably comprises a selection operating unit which allows a player to decide whether or not to substitute the symbol column type. When the selection operating unit receives an instruction from the player to substitute the symbol column type, the arrangement type lottery unit will retrieve another symbol column type, and the display control unit will cause the display unit to change the display so that the symbol columns of the type retrieved by the arrangement type lottery unit will be substituted for the symbol columns that have already been displayed by the display unit. In this gaming device of the present invention, the player can decide whether or not to substitute the symbol column type. In this way, the player can decide to continue the game with the symbol columns that have already been displayed.

The above-described gaming device of the present invention preferably comprises, in addition to the selection operating unit, a bet accepting unit which accepts the input of a bet from the player, and a coin storage unit which stores the bet and a payout for the bet. In this situation, when the selection operating unit receives an instruction from the player to substitute the symbol column type, the coin storage unit will reduce the bet or payout. This allows specifications which require the bet or payout, that is, a credit stored in the coin storage unit, to be reduced as the cost of the player's request for the substitution of the symbol column type.

When the above-described gaming device of the present invention comprises the above-described bet accepting unit, it is preferable that when the arrangement type lottery unit retrieves a new symbol column type, the starting unit will wait to generate the start signal until the bet accepting unit accepts the input of a new bet. This allows a gaming device to be designed so that the addition of a new bet will enable the substitution of the symbol column type. For example, in a situation in which a symbol column type includes an arrangement corresponding to a large payout, a specification will be possible in which credit will be consumed as a cost of obtaining the right to substitute to that symbol column type. Alternatively, a condition may also be established in order to substitute the symbol column type with respect to the bet placed. More preferably, in the gaming device of the present invention, the bet accepting unit will use at least a portion of the bet or payout stored in the coin storage unit as a new bet. This allows a gaming device design in which the player can use some of the credit stored in the coin storage unit as an additional bet.

When the above-described gaming device of the present invention includes the selection operating unit, it is preferable for the selection operating unit to allow the player to select a condition for the symbol column type to be substituted, and when the selection operating unit receives an instruction from the player to select the condition, the arrangement type lottery unit will select the type to be substituted from amongst the symbol columns which satisfy that condition by using a lottery process. For example, the player will select a condition under which a wild or PIC (picture) symbol appears with a high probability, and then a lottery process will select the symbol column type to be substituted from amongst the group of symbol columns that satisfy that condition. As a result, variations will be produced in the process until the symbol column type is actually substituted, and thus the variety of the game can be further increased.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a gaming device according to an embodiment of the present invention;

FIG. 2 is a block diagram which shows the electronic configuration of the main portion of the gaming device according to Embodiment 1 of the present invention;

FIG. 3 shows a first symbol column type according to Embodiment 1 of the present invention;

FIG. 4 shows a second symbol column type according to Embodiment 1 of the present invention;

FIG. 5 shows a third symbol column type according to Embodiment 1 of the present invention;

FIG. 6 shows a fourth symbol column type according to Embodiment 1 of the present invention;

FIG. 7 shows a fifth symbol column type according to Embodiment 1 of the present invention;

FIG. 8 shows a symbol column table according to Embodiment 1 of the present invention;

FIG. 9 shows a pay table according to Embodiment 1 of the present invention;

FIG. 10 is a flow chart which shows the characteristic operation of the gaming device according to Embodiment 1 of the present invention;

FIG. 11 is a block diagram which shows the electronic configuration of the main portion of the gaming device according to Embodiment 2 of the present invention;

FIG. 12 is a flow chart which shows the characteristic operation of the gaming device according to Embodiment 2 of the present invention; and

FIG. 13 shows a symbol column type according to Embodiment 3 of the present invention.

### DETAILED DESCRIPTION OF THE PREFERRED EMBODIMENTS

### Embodiment 1

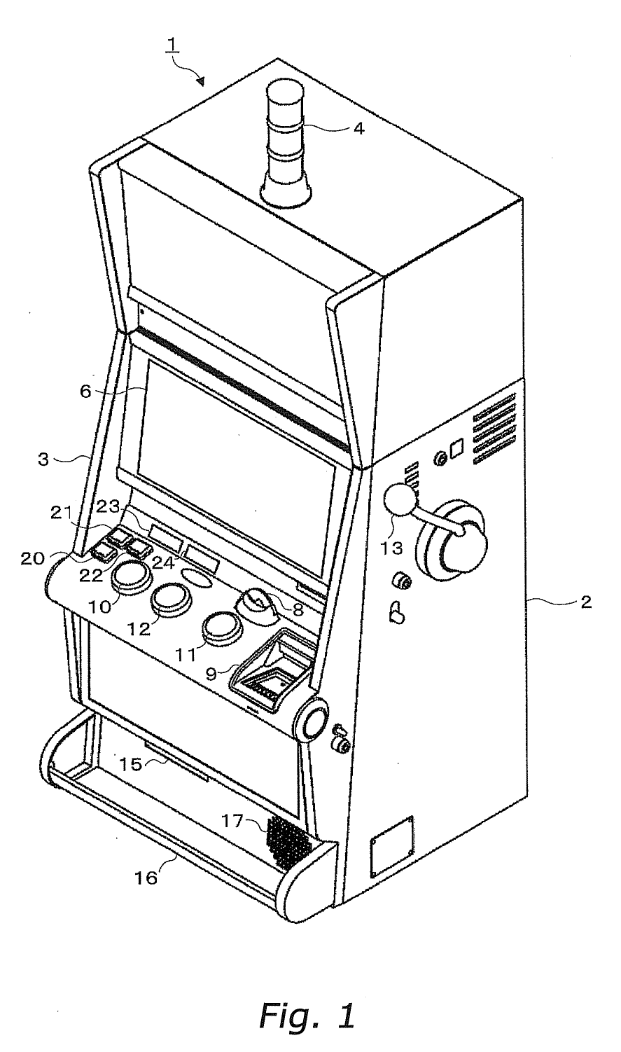

An embodiment of the present invention will be explained below with reference to the drawings. FIG. 1 is a perspective view of a gaming device according to an embodiment of the present invention. The gaming device 1 is a so-called video reel gaming device. The video reels have symbols that are displayed on a screen, and thus mechanical reels and the control thereof are unnecessary. This accordingly simplifies the design of a display unit, and further eliminates the need for maintenance of the display unit. Furthermore, there is a less severe restriction in the selection range of the symbols in video reels than in mechanical reels. The gaming device 1 includes a cabinet 2, and a front panel 3 which is installed on the front surface of the cabinet 2 so as to be openable and closable, as shown in FIG. 1. A lamp 4 is placed on the top of the cabinet 2.

A display unit 6 is installed on the rear portion of the front panel 3. Five symbol columns are displayed on the display unit 6. The display modes for each symbol column are primarily divided into two modes: a moving mode in which symbols continuously move in a column direction (the vertical direction of the gaming machine 1), and a stopping mode in which symbols are stopped. The symbol columns can be displayed in both of the two modes, independently of each other. In addition, operating instructions for a game are displayed on the display unit 6. The display unit 6 preferably includes a liquid crystal display device. Alternatively, any display device which can display the symbol columns, such as a CRT or an organic LED, may be used as the display unit 6.

A coin slot 8 and a bill slot 9 are installed on the front surface of the cabinet 2. A bet button 10 and a MAX bet button 11 each function as a bet accepting unit. More specifically, the bet button 10 is a button which allows a player to enter an instruction to use a predetermined number of coins (i.e., credit) stored in a coin storage unit (not shown) as a bet. On the other hand, the MAX bet button 11 is a button which allows a player to enter an instruction to use the maximum allowable number of coins (credits) stored in the coin storage unit. A spin button 12 and a spin lever 13 each function as a starting unit, i.e., they are input devices which allow the player to enter an instruction to start the moving mode of the symbols displayed by the display unit 6. The spin button 12 and the spin lever 13 each generate a start signal when operated by the player (as described later). A coin outlet 15, a coin receiver 16, and a speaker 17 are installed in the lower portion of the front panel 3. A payout button 20 allows a player to enter an instruction to discharge the coins stored in the coin storage unit. A change button 21 lights the lamp 4 on the top of the gaming device 1. The illuminated lamp 4 informs service personnel of a request for change from a player. A help button 22 allows a player to enter an instruction to display information such as directions for playing a game and the payout on the display unit 6. A payout display unit 23 displays the number of coins to be discharged from the coin outlet 15. A credit display unit 24 displays the number of coins stored in the coin storage unit. Both the payout and credit display units 23 and 24 preferably use an LED. In the alternative, a liquid crystal display may be used.

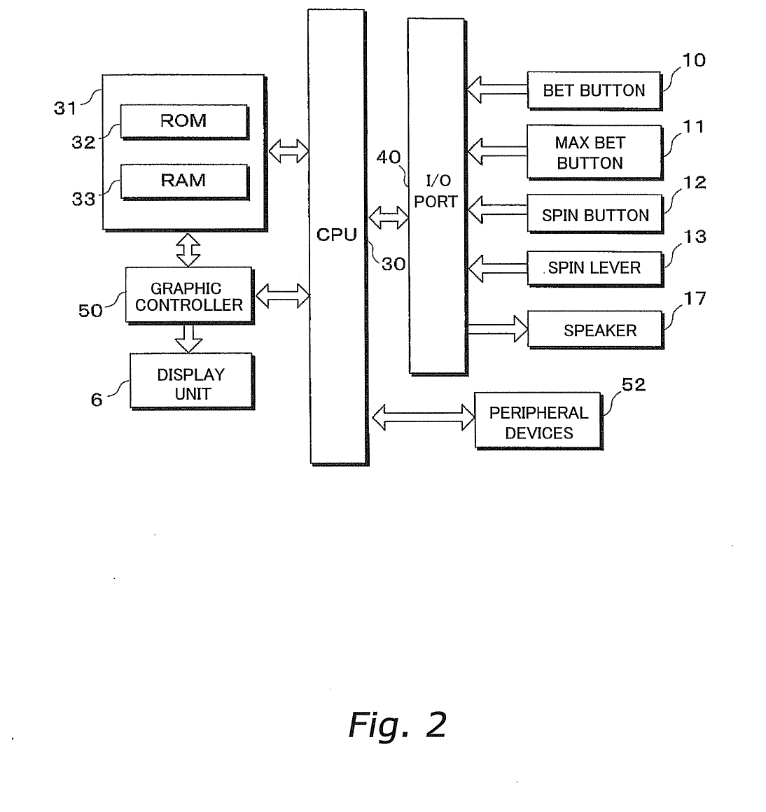

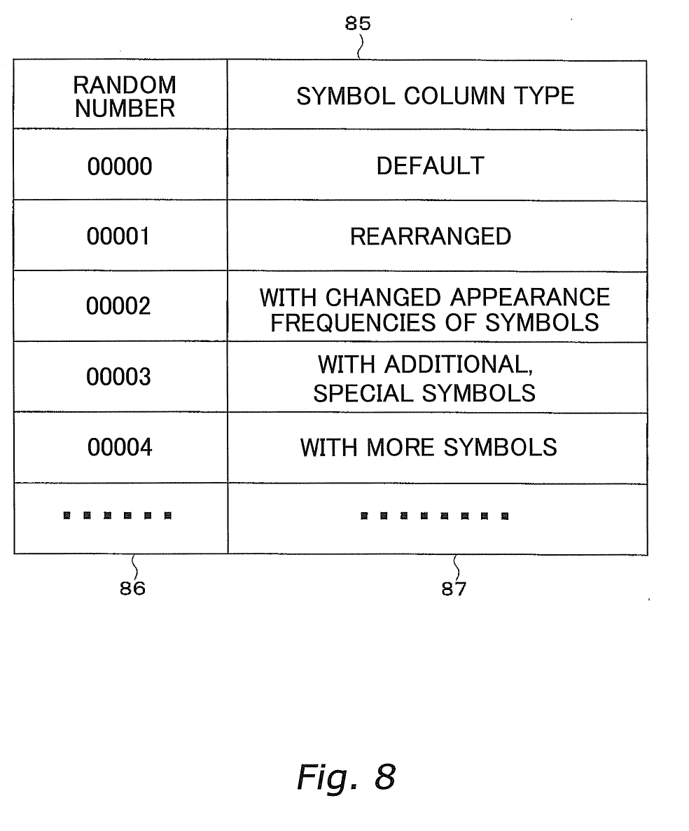

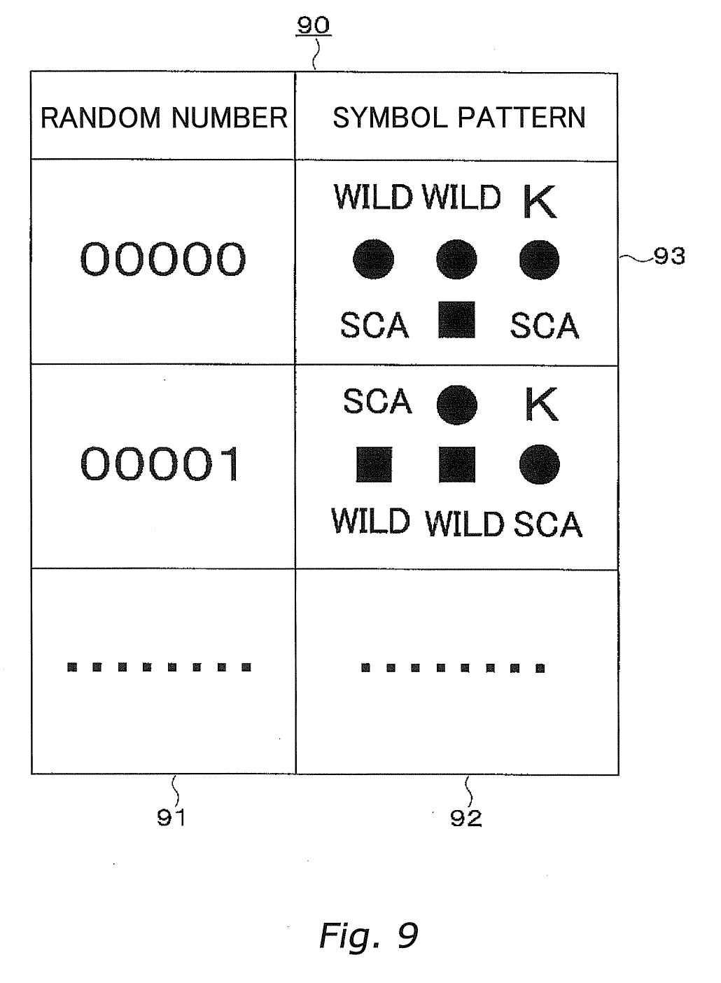

FIG. 2 is a block diagram which shows the electronic configuration of the main portion of the gaming device 1. A memory 31 is a storage unit, and preferably comprises a ROM 32 and a RAM 33. Programs for control over the operation of the gaming device 1, programs for various visual effects, and various types of image data to be displayed by the display unit 6, and the like, are stored in the memory 31. In particular, a symbol column table and a pay table are stored in the memory 31. Here, the symbol column table is a table which shows the corresponding relationships between the symbol column types and random numbers or the combinations of random numbers (See FIG. 8). On the other hand, the pay table is a table which shows the relationships between one or more prizes, specific arrangements of symbols, and specific random numbers (See FIG. 9).

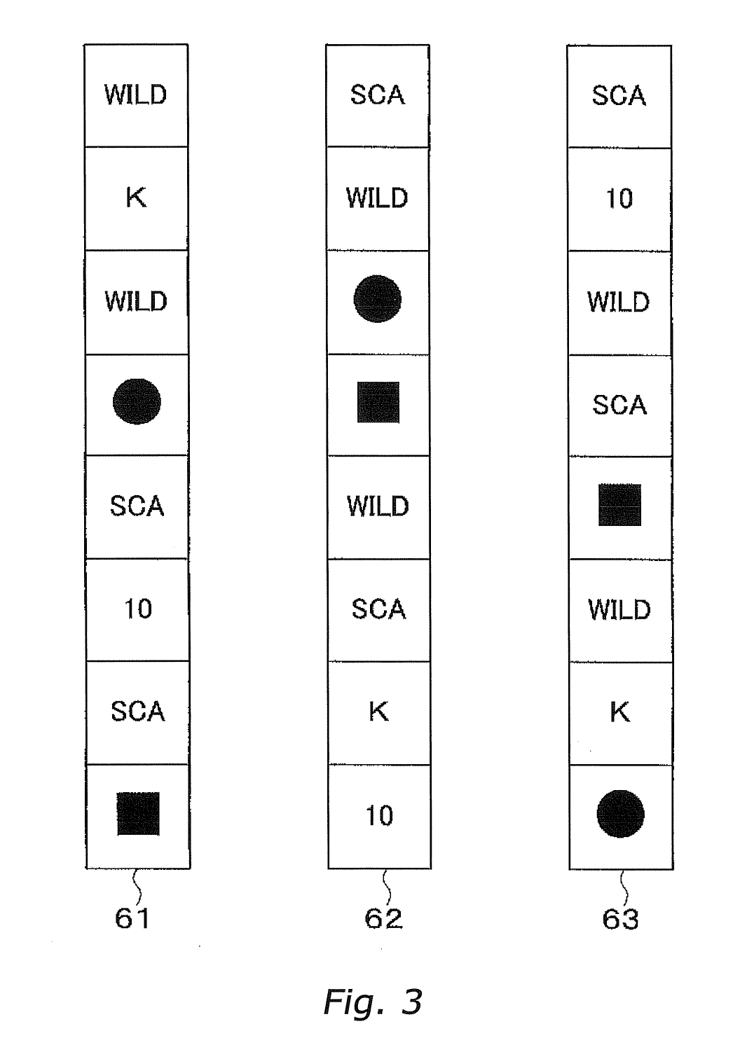

A CPU 30 runs programs stored in the memory 31, and thereby processes data entered through an I/O port 40, and, based on the data, controls each unit of the gaming device 1 and peripheral devices 52. Here, the CPU 30 is connected to the bet button 10, the MAX bet button 11, the spin button 12, the spin lever 13, and the speaker 17, through the I/O port 40. The CPU 30, in particular, receives the start signal sent from the bet button 10 or the spin button 12 through the I/O port 40. In response to the start signal, the CPU 30 functions as a random number generating unit, that is, generates a random number or a combination of random numbers. The CPU 30 further functions as an arrangement type lottery unit, i.e., the CPU 30 will retrieve the symbol column type corresponding to the generated random number or combination of random numbers from the symbol column table (See FIGS. 3-8). Thus, in the gaming device 1, each symbol column type to be displayed by the display unit 6 is switched at random, based on a random number. Moreover, the CPU 30 functions as a display control unit, that is, controls the display unit 6 through a graphic controller 50. Here, the graphic controller 50 performs image processing of the image data sent from the CPU 30, and then sends the processed image data to the display unit 6. The display unit 6 reproduces characters, still pictures, motion pictures, and so on, on a screen in accordance with the image data sent from the graphic controller 50. After retrieving a symbol column type, the CPU 30 will first change the display of the symbol columns by the display unit 6. In particular, the display unit 6 displays the substitution of the retrieved symbol column type for the symbol columns which have already been displayed by the display unit 6. Thus, the symbol column type will be changed during the course of the game, and in addition, the player will be allowed to see the changes. Preferably, a symbol arrangement corresponding to a payout which rarely appears under normal conditions will appear at comparatively frequent intervals while the display unit 6 displays the symbol columns in the moving mode. By applying this type of dynamic display to the display of the symbol columns, the player will maintain interest in the game for a longer period of time. In addition, a less severe restriction will be placed on the selection range of symbols, because the types of symbols that can be displayed are not limited to the symbols included in specific symbol columns. In this way, the burden on the designers of the symbol column types will be reduced. The CPU 30 also functions as a winning determination unit. In other words, the CPU 30 will perform an internal lottery process based on the newly retrieved symbol column type, will determine the symbol arrangement to be finally displayed by the display unit 6 from the results of the internal lottery process, and thereafter will retrieve the symbol arrangement from the pay table in order to determine the prize to be awarded to the player. The CPU 30 again functions as a display control unit, thereby controlling the display of the symbol columns by the display unit 6 as follows. The CPU 30 first causes the display unit 6 to display the new symbol column type in the moving mode for a predetermined period of time. In the moving mode, the symbols included in each symbol column continuously move in the column direction. After that, the CPU 30 will change the display mode of the display unit 6 from the moving mode to the stopping mode, and thereby causes the display unit 6 to stop the symbols of the symbol columns at predetermined positions, and display the symbol arrangement determined by the internal lottery process on the display unit 6. Here, each symbol column is stopped at predetermined time intervals, for example, in the order in which they are arranged from left to right on the screen of the display unit 6. In this case, the stop timing may be set at the time when a fixed period of time has elapsed from the game start, or may be changed for every game. When all of the symbol columns stop, and a specific symbol arrangement representing a win is displayed by the display unit 6, the player can win a prize corresponding to the specific symbol arrangement.

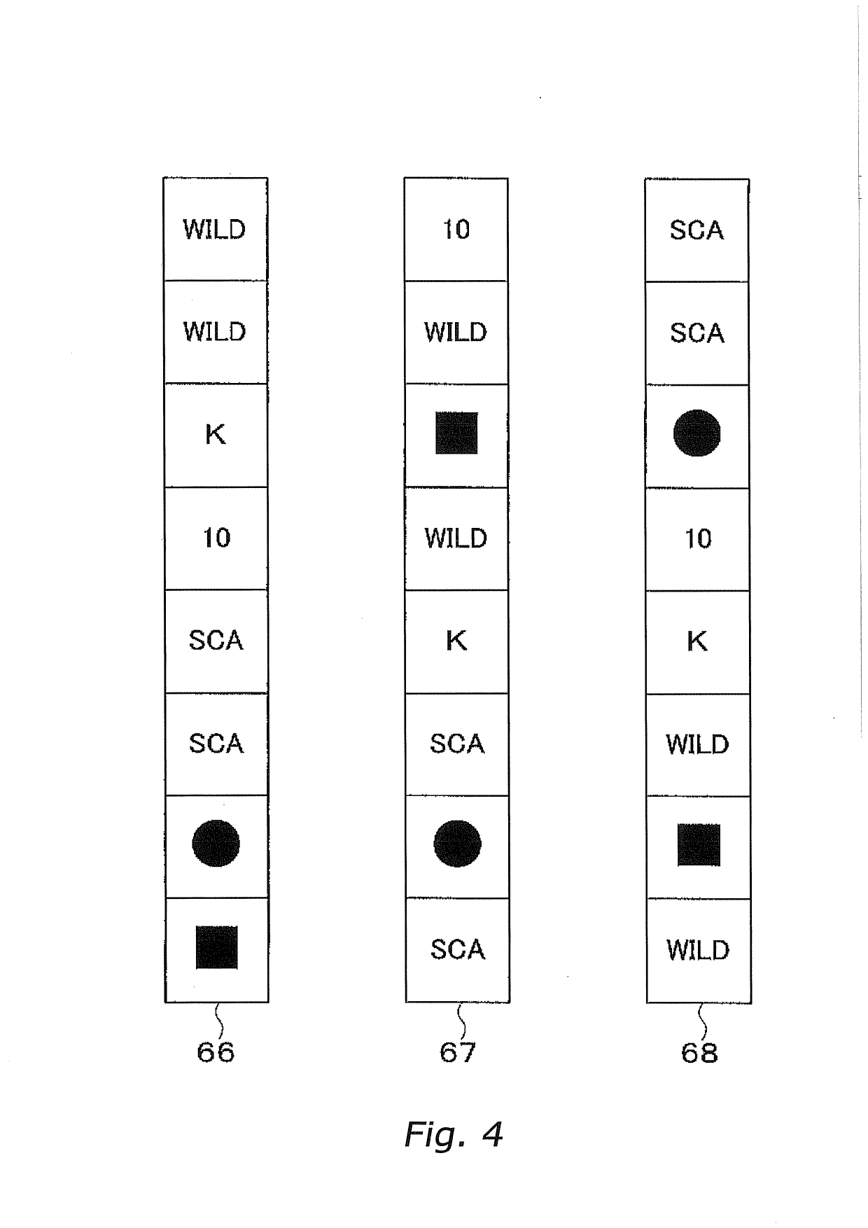

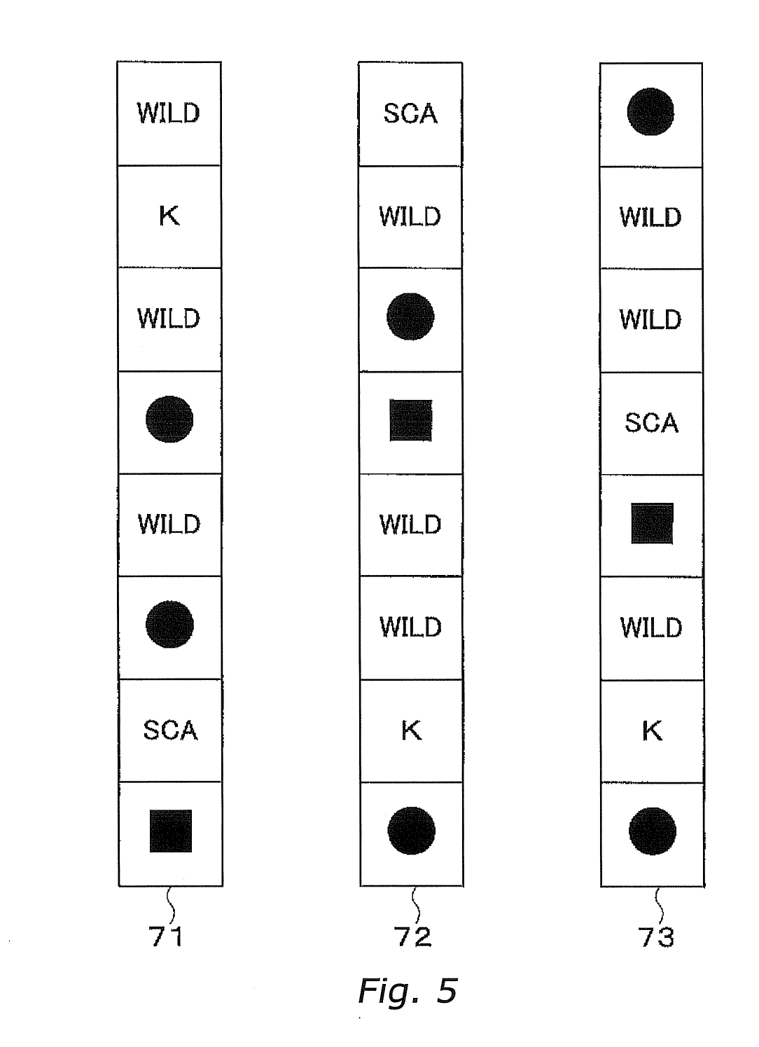

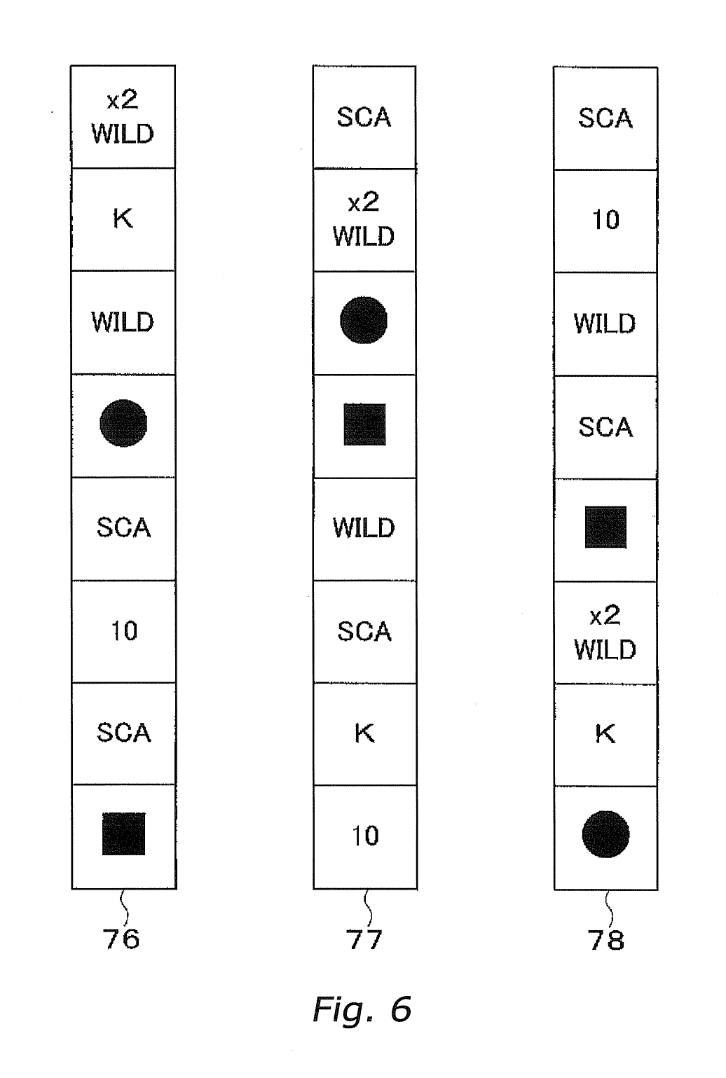

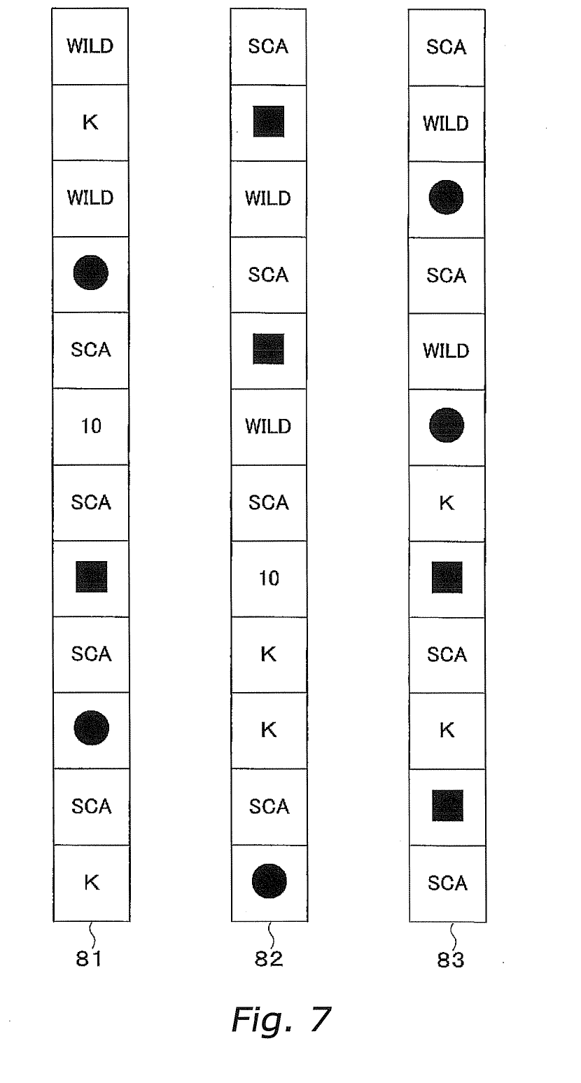

FIGS. 3-7 show five symbol column types. These types are stored in the memory 31. Each type is matched with a specific random number or combinations of random numbers, and the corresponding relationships are stored in the memory 31 as the symbol column table. A first type of symbol columns 61-63 shown in FIG. 3 is an example of symbol columns used under normal conditions, i.e., the default setting. Preferably, a higher weight is assigned to the first type of symbol columns 61-63 than to other types. Here, the symbol column types with higher payout probabilities have lower weights, and thus appear with lower probabilities. Accordingly, the first type of symbol columns 61-63 is the type which appears most frequently. The first type of symbol columns 61-63 include, for example, PIC symbols which are solid black circles and squares, card symbols “10” and “K,” wild symbols “WILD,” and scatter symbols “SCA,” which are arranged at standard proportions as shown in FIG. 3. Here, the wild symbol is a symbol which can substitute for any other symbol. On the other hand, the scatter symbol is a symbol whose occurrence results in a predetermined prize to be awarded to the player regardless of the stop position of the symbol. A second type of symbol columns 66-68 shown in FIG. 4 has a different arrangement than the first type of symbol columns 61-63. For example, one symbol column 61 of the first type and a corresponding symbol column 66 of the second type each include two wild symbols and two scatter symbols, one solid circle and square PIC symbols, and one “10” and “K” card symbols. However, the symbol columns 61 and 66 have different symbol arrangements. Other symbol columns have similar features. Accordingly, the first type of symbol columns 61-63 and the second type of symbol columns 66-68 have the same frequencies with which the symbols appear, but different arrangements of the symbols. A third type of symbol columns 71-73 shown in FIG. 5 has symbols which appear at a different frequency than the first type of symbol columns 61-63. The different appearance frequencies necessarily involve different arrangements of symbols. For example, one symbol column 61 of the first type includes two wild symbols and scatter symbols. On the other hand, a corresponding symbol column 71 of the third type includes three wild symbols and a single scatter symbol. Symbol columns 76-78 of a fourth type shown in FIG. 6 each include an additional, special symbol “x2WILD,” which is not included in the other types of symbol columns. In particular, each of the fourth type of symbol columns 76-78 is one in which the special symbol “x2WILD” is substituted for one of the wild symbols “WILD” included in the corresponding symbol columns 61-63 of the first type. Here, the special symbol “x2WILD” is, for example, a symbol provided with an additional, special role in doubling any winning payout, as well as the role of the wild symbol, which can substitute for any other symbol. Symbol columns 81-83 of a fifth type shown in FIG. 7 each include more symbols than the other types of symbol columns. In FIG. 7, for example, the number of symbols per column in the fifth type of symbol columns 81-83 is larger by four than that of the other types of symbol columns. The gaming device 1 will change all of the symbol columns by switching between the above-described various types of symbol columns. In this way, the gaming device 1 will further vary the game balance which can be achieved in a single game, in contrast to a conventional gaming device which substitutes a portion of the symbols included in the symbol columns. Preferably, a symbol arrangement corresponding to a large payout which rarely appears under normal conditions will appear at comparatively frequent intervals while the display unit 6 displays the symbol columns in the moving mode. This can further raise the expectations of the player. The substitution of the types of symbol columns allows designers to flexibly set the appearance frequencies of each symbol and the number of symbols per symbol column. Accordingly, the games of the gaming device 1 are easy to adjust. Note that all of the types of symbol columns shown in FIGS. 3-7 are examples, and other types may be adopted. For example, all of the symbols included in a symbol column may be different from each other. Alternatively, a symbol column may be adopted in which the card, PIC, or scatter symbols can appear with even higher probabilities.

FIG. 8 shows an outline of the symbol column table 85. The symbol column table 85 is stored in the memory 31. As illustrated in FIG. 8, each random number shown in the left column 86 of the symbol column table 85 is matched with a symbol column type in the right column 87 of the table. In addition, a weight (not shown) is assigned to each of the types. The CPU 30, when functioning as the arrangement type lottery unit, will perform a lottery process in which the symbol column types are provided with probabilities corresponding to their respective weights, thereby determining the type of symbol column to be displayed by the display unit 6.

FIG. 9 shows an outline of the pay table 90. The pay table 90 is stored in the memory 31. As illustrated in FIG. 9, each random number shown in the left column 91 of the pay table 90 is matched with a symbol arrangement shown in the right column 92 of the table. For example, when the CPU 30 functioning as the winning determination unit generates a random number “00000,” the symbol arrangement shown in the top item 93 of the right column 92 of FIG. 9 is displayed by the display unit 6 in the stopping mode. Here, the gaming device 1 preferably has a different pay table for every type of symbol column. Every time the type of symbol columns is decided in the lottery process, the CPU 30 reads and uses the pay table corresponding to the type from the memory 31. In FIG. 9, for example, the symbol arrangements shown in the right column 92 are based on the first type of symbol columns shown in FIG. 3. Preferably, the pay table 90 covers all the symbol arrangements which can be composed from the first type of symbol columns. Alternatively, for example, when a portion of the symbol columns of one type are set as another type, a portion of the pay table for the former may be used as the pay table for the latter. Note that FIG. 9 illustrates the symbol arrangements as images, but actually, the numbers used in the positioning of each symbol are matched with each random number shown in the left column 91. Furthermore, a combination of two or more random numbers, instead of a single random number as shown in FIG. 9, may be matched with a single pattern of symbols. In particular, random numbers equal to the number of symbol columns may be generated and matched with the stop positions of the respective symbol columns.

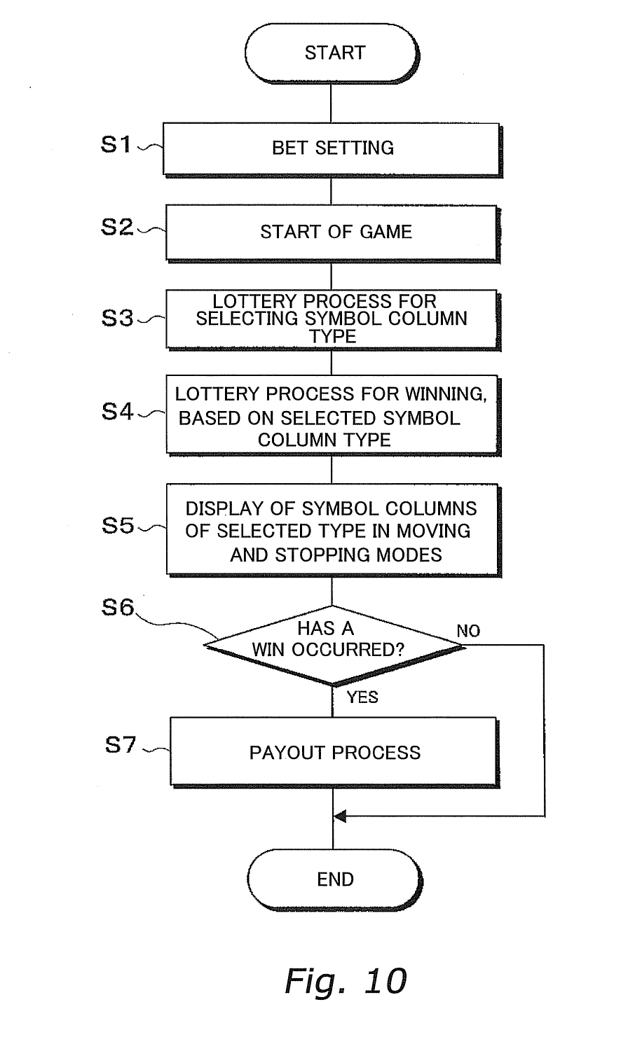

Next, the operation of the gaming device 1 will be explained. FIG. 10 is a flow chart which shows the characteristic operation of the gaming device 1. First, the player enters a bet (Step S1). The player will insert one or more coins in the coin slot 8, or will push the bet button 10 to enter an instruction to use coins stored in the coin storage unit, and thereby set the bet. When the MAX bet button 11 is pushed, the allowable maximum number of coins is set as the bet. Furthermore, these operations may be used together. Additional bets may enable additional winning lines. After the bet is set, the player pushes the spin button 12 or pulls the spin lever 13, and then a start signal is generated and the game starts (Step S2). Upon receipt of the start signal, the CPU 30 determines the symbol column type by using the lottery process (Step S3). More specifically, the CPU 30 first generates a random number or a combination of random numbers. The CPU 30 next reads the symbol column table 85 from the memory 31, and retrieves the symbol column type corresponding to the generated random number or combination of random numbers from the symbol column table 85. Here, the probability in which a symbol column type will be selected will depend on the weight assigned to each symbol column type in advance. In particular, the gaming device 1 always determines the symbol column type by using the lottery process immediately after a game is started. The CPU 30 then performs an internal lottery process that uses the symbol column type determined in the previous lottery process, thereby judging whether to award a prize to the player (Step S4). More specifically, the CPU 30 first generates a new random number or combination of random numbers. The CPU 30 next reads the pay table 90 from the memory 31, and retrieves a symbol arrangement corresponding to the generated random number or combination of random numbers from the pay table 90. The CPU 30 further causes the display unit 6 to start symbol display in the moving mode (Step S5). More specifically, the CPU 30 first reads the symbol column type determined in the lottery process from the memory 31, and constructs image data which represents the corresponding symbol columns, based on the symbol column type, and then transfers the image data to the display unit 6. The display unit 6 preferably displays symbol columns such that the current symbol columns move in the column direction, preferably the downward direction over the screen, and then disappear from the screen. After that, the symbol columns of the new type appear, preferably from the top of the screen. Preferably, the symbol columns of the new type which appear are successively displayed in the moving mode. When a predetermined time has elapsed, the CPU 30 changes the moving mode to the stopping mode, preferably column by column. In this way, the changes in the display of the symbol columns stop one after another, and finally, the symbol arrangement determined in the internal lottery process appears. The CPU 30 judges whether a win has occurred based on the symbol arrangement determined in the internal lottery process (Step S6). If no win has occurred, the game ends. When a win has occurred, the display unit 6 displays images which show the win, and the CPU 30 performs a normal payout process (Step S7).

### Embodiment 2

In Embodiment 1 of the present invention as described above, the lottery process determines the symbol column type every time a game is started by operation of the spin button 12 or the spin lever 13. On the other hand, Embodiment 2 of the present invention comprises a selection operating unit which causes a player to decide whether to substitute the symbol column type.

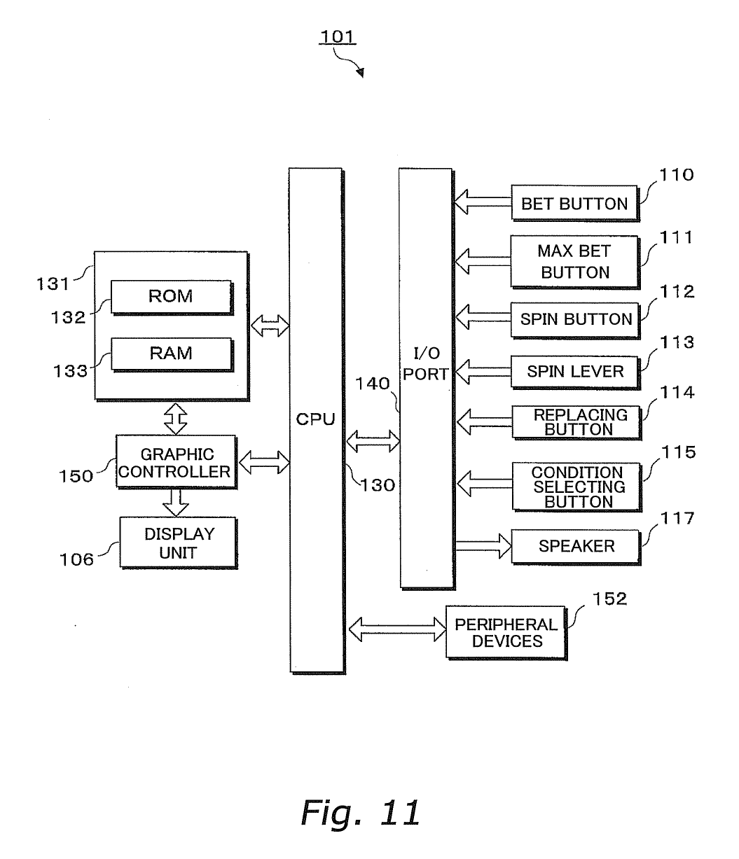

FIG. 11 is a block diagram which shows the electronic configuration of a gaming device according to Embodiment 2 of the present invention. This gaming device 101 comprises, in particular, a replacing button 114 and a condition selecting button 115, which are used as a selection operating unit. A memory 131 is a storage unit similar to the memory 31 according to Embodiment 1, and preferably comprises a ROM 132 and a RAM 133. Programs for control over the operations of the gaming device 101, a symbol column table, a pay table, and so on, are stored in the memory 131.

A CPU 130 functions similarly to the CPU 30 according to Embodiment 1. In other words, the CPU 130 runs programs stored in the memory 131, and thereby processes data entered through an I/O port 140, and, based on the data, controls units included in the gaming device 101 and peripheral devices 152. Here, the CPU 130 is connected to a bet button 110, a MAX bet button 111, a spin button 112, a spin lever 113, the replacing button 114, the condition selecting button 115, and a speaker 117 through the I/O port 140. The spin button 112 and the spin lever 113 each generate a start signal by being operated by a player. The CPU 130 receives the start signal sent from the bet button 110 or the spin button 112 through the I/O port 140. In response to the start signal, the CPU 130 generates a random number or a combination of random numbers, and determines the symbol column type based on the random number or combination by using a lottery process. The CPU 130 further controls a display unit 106 through a graphic controller 150. Here, the graphic controller 150 performs image processing of the image data sent from the CPU 130, and then sends the processed image data to the display unit 106. The display unit 106 reproduces characters, still pictures, motion pictures, and so on, on a screen in accordance with the image data sent from the graphic controller 150. In particular, when the player pushes the replacing button 114, the display unit 106 displays the substitution of the symbol columns of the type determined by the lottery process with the symbol columns which have already been displayed by the display unit 106. The CPU 130 next causes the display unit 106 to display the symbol columns in the moving mode for a predetermined period of time, and then will change the moving mode to the stopping mode. On the other hand, the CPU 130 performs an internal lottery process, based on the new type of symbol columns, and retrieves a final symbol arrangement and a corresponding prize from the pay table, based on the result of the internal lottery process.

Preferably, when entering a bet, the player will push the replacing button 114, and thereby instruct the CPU 130 to substitute the symbol column type. When the replacing button 114 is pushed, symbol columns of the type determined in the lottery process are substituted for the symbol columns that have already been displayed by the display unit 106, and then the game progresses. If the replacing button 114 is not pushed, the game progresses with the current symbol columns that have already been displayed by the display unit 106. Thus, the player can decide whether to substitute the type of symbol columns. In particular, the player can select the continuation of the game with the symbol columns which have already been displayed.

The player will further select the condition relating to the symbol column type to be substituted, preferably at the setting of a bet, by using the condition selecting button 115. Preferably, when the condition selecting button 115 is pushed, the symbol column type which satisfies the selected condition is selected from the symbol column types stored in the memory 131. Furthermore, a lottery process selects one of the symbol column types as the type to be actually substituted. Preferably, when the condition “a winning combination corresponding to a large payout can appear” is set to be available and is actually selected by the player, the lottery process selects the symbol column type to be substituted from the group of symbol column types in which a winning combination corresponding to a large payout can appear. Alternatively, when the condition “wild or PIC symbols appear with high probabilities” is selected, the lottery process selects the symbol column type to be substituted from a group consisting of this symbol column type. This type of specification will produce variations in the process until the substitution, and thus can further increase game variety.

Preferably, credits stored in the coin storage unit are consumed when the replacing button 114 or the condition selecting button 115 is pushed. This can reduce player credit as the cost of the player's request for the substitution of the symbol column type. In particular, a reasonable amount of credit can be consumed as the cost of a request for use of a symbol column type which includes an arrangement corresponding to a large payout. Alternatively, the player may be allowed to enter an instruction to substitute the symbol column type by adding a bet, instead of pushing the replacing button 114 or the condition selecting button 115. In this case, newly inserted coins are, preferably, used as the additional bet. Preferably, the gaming device 101 is designed so that the symbol column type may be substituted only when a bet is added. For example, the spin button 112 and the spin lever 113 will both wait to generate a start signal until a new bet is input, regardless of the player's operation. This can cause a reasonable amount of credit to be consumed as a cost of a request for use a symbol column type which includes an arrangement corresponding to a large payout.

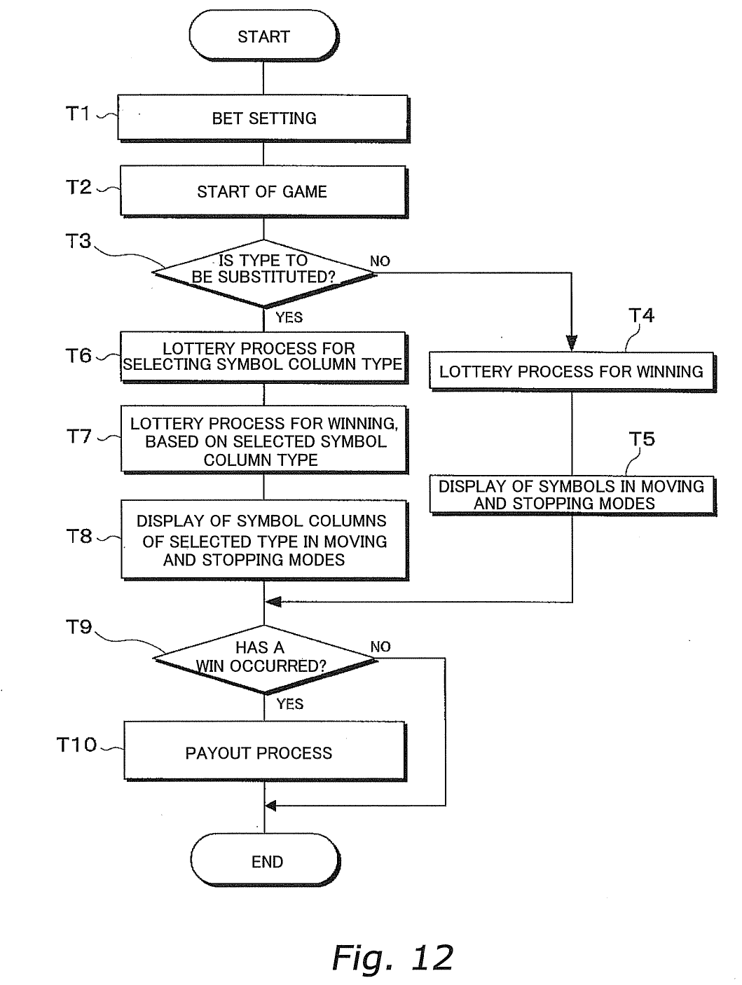

Next, the operation of the gaming device 101 will be explained. FIG. 12 is a flow chart which shows the characteristic operation of the gaming device 101. First, the player enters a bet (Step T1). At this time, the player can push the replacing button 114, and thereby enter an instruction to substitute the symbol column type. Furthermore, the player can push the condition selecting button 115, and thereby select a condition regarding the symbol column type to be substituted. After the bet is set, the player pushes the spin button 112 or pulls the spin lever 113, and then a start signal is generated and the game will start (Step T2). Upon receipt of the start signal, the CPU 130 will first determine the presence or absence of the player's instruction to substitute the symbol column type (Step T3). If there is no instruction, the CPU 130 performs an internal lottery by using the symbol columns which have already been displayed by the display unit 106 (Step T4). More specifically, the CPU 130 first generates a random number or a combination of random numbers. The CPU 130 next reads the pay table from the memory 131, and retrieves a symbol arrangement corresponding to the generated random number or combination of random numbers from the pay table. The CPU 130, preferably, causes the display unit 106 to display in the moving mode for a predetermined time, and then changes the moving mode to the stopping mode (Step T5). In this way, the changes in the display of the symbol columns stop one after another, and finally, the symbol arrangement determined in the internal lottery process appears. When the player's instruction to substitute the symbol column type is determined to be present, the CPU 130 will determine the symbol column type to be substituted by using the lottery process (Step T6). More specifically, the CPU 130 first generates a random number or a combination of random numbers. The CPU 130 next reads the symbol column table from the memory 131, and retrieves the symbol column type corresponding to the generated random number or combination of random numbers from the symbol column table, and then sets the symbol column type to be substituted. Note that, when a predetermined condition is selected by using the condition selecting button 115, the symbol column type which satisfies the condition will be selected. The CPU 130 then performs an internal lottery process that uses the symbol column type determined in the previous lottery process (Step T7). After that, the CPU 130 causes the display unit 106 to start symbol display in the moving mode (Step T8). More specifically, the CPU 130 first reads the symbol column type determined in the lottery process from the memory 131, and constructs image data which represents the corresponding symbol columns, based on the symbol column type, and then transfers the image data to the display unit 106. The display unit 106 preferably displays the symbol columns such that the current symbol columns move in the column direction, preferably the downward direction over the screen, and then disappear from the screen. After that, the new type of symbol columns appear, preferably from the top of the screen. Preferably, the new type of symbol columns which appear are successively displayed in the moving mode. When a predetermined period of time has elapsed, the CPU 130 changes the moving mode to the stopping mode, preferably column by column. In this way, the changes in the display of the symbol columns stop one after another, and finally, the symbol arrangement determined in the internal lottery process appears. The CPU 130 judges whether a win has occurred based on the symbol arrangement determined in the internal lottery process (Step T9). If no win has occurred, the game ends. When a win has occurred, the display unit 106 displays images which show the win, and the CPU 130 performs a normal payout process (Step T10).

### Embodiment 3

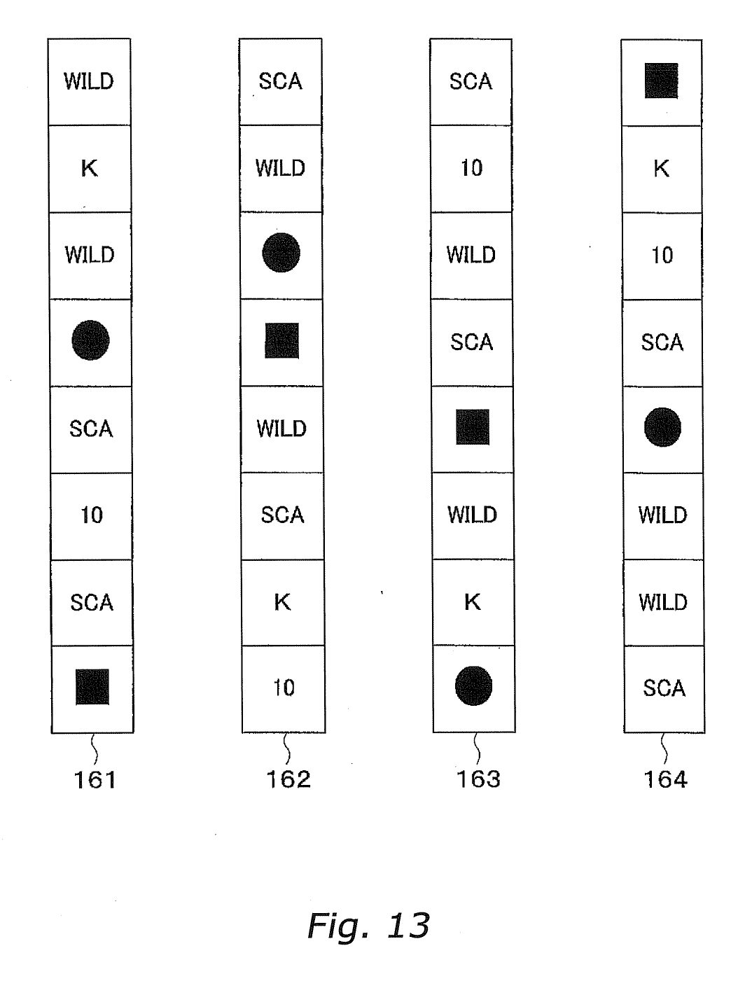

In Embodiment 1, the number of symbol columns does not change since all symbol column types consist of three symbol columns. However, the number of symbol columns may change by substitution of the type thereof. FIG. 13 shows a symbol column type consisting of four symbol columns 161-164, in contrast to the symbol column types shown in FIGS. 3-7. A gaming device according to Embodiment 3 is similar in configuration and operation to the gaming device according to Embodiment 1. However, the former is different from the latter in the following points. The gaming device according to Embodiment 3 stores a symbol column type in memory which consists of four symbol columns 161-164, in addition to the types which consist of three symbol columns shown in FIGS. 3-7. Together therewith, a pay table for the type which consists of four symbol columns is stored in memory, in addition to the pay tables for the types which consist of three symbol columns. When the symbol column type is determined by using a lottery process, a CPU will read a pay table from memory that corresponds to the number of symbol columns which constitute the determined type, and then uses the pay table to determine whether there is a win. This allows the symbol columns to change in number, for example, from three to four, and accordingly, can further increase the variety of the games.

All the above-described gaming devices according to Embodiments 1-3 are video reel gaming devices. However, any of the gaming devices may be a gaming device which uses so-called mechanical reels. In that case, any mechanism which can mechanically exchange an entire reel, such as a turntable, will allow the symbol column types to be substituted.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A gaming device which awards a prize to a player in accordance with an arrangement of a plurality of symbols, comprising:
a display unit that displays at least a portion of a plurality of aligned symbol columns, each symbol column having a plurality of symbols;
a storage unit that stores a symbol column table showing the corresponding relationships between symbol column types and specific random numbers or specific combinations of random numbers, as well as a pay table showing the corresponding relationships between one or more prizes with a specific symbol arrangement;
a starting unit that generates a start signal in order to start a game, in response to an operation of a player;
a random number generating unit which generates a random number or a combination of random numbers upon receipt of the start signal;
an arrangement type lottery unit which retrieves, from the symbol column table, the symbol column type corresponding to the random number or the combination of random numbers generated by the random number generating unit;
a winning determination unit which performs an internal lottery based on the symbol column type retrieved by the arrangement type lottery unit, determines a final symbol arrangement to be displayed from the result of the internal lottery, and retrieves the final symbol arrangement from the pay table in order to determine a prize to be awarded to the player; and
a display control unit that causes the display unit to change the display of the symbol columns so that symbol columns of the type retrieved by the arrangement type lottery unit are substituted for the symbol columns that have already been displayed by the display unit, and the symbols included in the substituted symbol columns continuously move in the column direction for a predetermined period of time, and thereafter cause the display unit to stop the moving symbol display so that the final symbol arrangement determined by the winning determination unit appears.

2. The gaming device according to claim 1, wherein the pay table differs for each symbol column type.

3. The gaming device according to claim 1, further comprising a selection operating unit which allows a player to decide whether or not to substitute the symbol column type; and
wherein when the selection operating unit receives an instruction from the player to substitute the symbol column type, the arrangement type lottery unit retrieves another symbol column type, and the display control unit will cause the display unit to change the display so that the symbol columns of the type retrieved by the arrangement type lottery unit are substituted for the symbol columns that have already been displayed by the display unit.

4. The gaming device according to claim 3, further comprising a bet accepting unit which accepts the input of a bet from a player, and a coin storage unit which stores the bet and a payout for the bet; and
wherein when the selection operating unit receives an instruction from the player to substitute the symbol column type, the coin storage unit will reduce the bet or payout.

5. The gaming device according to claim 1, further comprising a bet accepting unit which accepts input of a bet from a player; and
wherein when the arrangement type lottery unit retrieves a new symbol column type, the starting unit will wait to generate the start signal until the bet accepting unit accepts the input of a new bet.

6. The gaming device according to claim 5, further comprising a coin storage unit which stores the bet and a payout for the bet; and
wherein the bet accepting unit uses at least a portion of the bet or payout stored in the coin storage unit as a new bet.

7. The gaming device according to claim 3, wherein the selection operating unit allows a player to select a condition for the symbol column type to be substituted; and
wherein when the selection operating unit receives an instruction from the player to select the condition, the arrangement type lottery unit will select the symbol column type to be substituted from the symbol column types that satisfy the condition by using a lottery process.

8. A method for awarding a prize to a player in accordance with an arrangement of a plurality of symbols displayed in a gaming machine, comprising steps of:
generating a start signal in order to start a game, in response to an operation of a player;
generating a random number or a combination of random numbers in response to the start signal, and retrieving, from a symbol column table, a symbol column type corresponding to the generated random number or the generated combination of random numbers;
performing an internal lottery based on the retrieved symbol column type, determining a final symbol arrangement to be displayed from the result of the internal lottery, and retrieving the final symbol arrangement from a pay table in order to determine a prize to be awarded to the player;
changing the display of symbol columns so that symbol columns of the retrieved type are substituted for the symbol columns that have already been displayed, and the symbols included in the substituted symbol columns continuously move in the column direction for a predetermined period of time; and
stopping the moving symbol display so that the determined final symbol arrangement appears.

9. The method according to claim 8, wherein the pay table differs for each symbol column type.

10. The method according to claim 8, further comprising steps of:
allowing a player to decide whether or not to substitute the symbol column type; and
when receiving an instruction from the player to substitute the symbol column type, retrieving another symbol column type, and changing the display of symbol columns so that the symbol columns of the retrieved type are substituted for the symbol columns that have already been displayed.

11. The method according to claim 10, further comprising steps of:
accepting input of a bet from a player; and
when receiving an instruction from the player to substitute the symbol column type, reducing the bet or payout of the player.

12. The method according to claim 8, further comprising steps of:
accepting input of a bet from a player; and
when retrieving a new symbol column type, waiting to generate the start signal until accepting the input of a new bet.

13. The method according to claim 12, further comprising a step of using at least a portion of the player's bet or payout stored in the gaming machine as a new bet.

14. The method according to claim 10, further comprising steps of:
allowing a player to select a condition for the symbol column type to be substituted; and
when receiving an instruction from the player to select the condition, selecting the symbol column type to be substituted from the symbol column types that satisfy the condition by using a lottery process.
